(19) United States
(12) Patent Application Publication
(10) Pub. No.: US 2017/0220184 A1
(43) Pub. Date: Aug. 3, 2017

(54) TOUCH DISPLAY PANEL AND MANUFACTURING METHOD THEREOF, DISPLAY APPARATUS AND DRIVING METHOD THEREFOR

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Yingming LIU, Beijing (CN); Xue DONG, Beijing (CN); Hailin XUE, Beijing (CN); Xiaochuan CHEN, Beijing (CN); Haisheng WANG, Beijing (CN); Xiaoliang DING, Beijing (CN); Weijie ZHAO, Beijing (CN); Shengji YANG, Beijing (CN); Lei WANG, Beijing (CN); Ming YANG, Beijing (CN); Changfeng LI, Beijing (CN); Wei LIU, Beijing (CN); Pengpeng WANG, Beijing (CN)

(21) Appl. No.: 15/279,121

(22) Filed: Sep. 28, 2016

(30) Foreign Application Priority Data
Feb. 3, 2016 (CN) 201610077901.X

(51) Int. Cl. G06F 3/041; G06F 3/044

(52) U.S. Cl. CPC G06F 3/0416; G06F 3/0414; G06F 3/044; G06F 3/0412; G06F 2203/04103; G06F 2203/04105; G06F 2203/04111

(57) ABSTRACT

A touch display panel and a manufacturing method thereof, a display apparatus comprising the touch display panel and a driving method for the display apparatus are provided. The touch display panel comprises a first substrate and a second substrate, which are disposed opposite to each other, strip-like touch sensing electrodes being provided at a side of the first substrate distal to the second substrate, the second substrate comprising block-like common electrodes, and the block-like common electrodes being arranged in strips, wherein, orthogonal projections of the strip-like touch sensing electrodes on the first or second substrate intersect with the strips of the block-like common electrodes, each strip of the common electrodes includes a plurality of driving electrodes and a plurality of pressure sensing electrodes, and the driving electrodes and the pressure sensing electrodes are arranged alternatively in a same layer.

### FIELD OF THE INVENTION

The present invention relates to the field of display technology, and in particular, relates to a touch display panel and a manufacturing method thereof, a display apparatus and a driving method therefor.

### BACKGROUND OF THE INVENTION

Pressure sensing technology refers to a technology in which an external pressure can be sensed. Currently, many companies are seeking for an appropriate solution to achieve pressure sensing in the display field (in particular, in the mobile application filed) so that users can obtain better human-computer interaction experiences.

Referring to FIG. 1, an existing touch display panel generally comprises a color filter substrate and an array substrate, which are disposed opposite to each other. Driving electrodes 101 are provided at a side of the array substrate proximal to the color filter substrate, and touch sensing electrodes 21 are provided at a side of color filter substrate distal to the array substrate. The driving electrodes 101 are strip electrodes arranged in parallel, and the touch sensing electrodes 21 are strip electrodes perpendicular to the driving electrodes 101.

However, there are at least the following problems existing in the prior art: the existing touch display panel cannot simultaneously achieve a touch control function and a pressure control function and has a low flexibility in operations. Moreover, in order to have the pressure control function, it is necessary to further provide a group of electrodes in the touch display panel for sensing a pressure, resulting in a complex structure and an increased cost of the touch display panel.

### SUMMARY OF THE INVENTION

In view of the problems that the existing touch display panel cannot simultaneously achieve the touch control function and the pressure control function, the present disclosure provides a touch display panel and a manufacturing method thereof, a display apparatus comprising the touch display panel and a driving method for the display apparatus, which can simultaneously achieve the touch control function and the pressure control function and have simple structures.

A technical solution employed by an embodiment of the present invention is a touch display panel comprising a first substrate and a second substrate, which are disposed opposite to each other, strip-like touch sensing electrodes being provided at a side of the first substrate distal to the second substrate, the second substrate comprising block-like common electrodes, and the block-like common electrodes being arranged in strips, wherein, orthogonal projections of the strip-like touch sensing electrodes on the first or second substrate intersect with those of the strips of the block-like common electrodes, each strip of the common electrodes includes a plurality of driving electrodes and a plurality of pressure sensing electrodes, and the driving electrodes and the pressure sensing electrodes are arranged alternatively in a same layer.

When a touch terminal touches a surface of the touch display panel, a touch capacitance is generated between the touch sensing electrodes and the driving electrodes, so that the touch display panel generates a touch control signal in accordance with the touch capacitance.

Optionally, orthogonal projections of the touch sensing electrodes on the first substrate cover orthogonal projections of the pressure sensing electrodes on the first substrate, that is, the pressure sensing electrodes are provided at positions corresponding to positions of the touch sensing electrodes.

In this case, when a touch terminal touches a surface of the touch display panel, the touch sensing electrodes prevent a parasitic capacitance from being generated between the touch terminal and the pressure sensing electrodes.

The touch sensing electrodes may be arranged in rows, and in this case, the common electrodes are arranged in columns.

The touch display panel may be an improved fringe filed switching type display panel.

As another technical solution, an embodiment of the present invention also provides a display apparatus comprising a touch display panel and a middle frame, the middle frame is configured to support the touch display panel and is made of a conductive metal, the touch display panel is any of the touch display panels described above, and the middle frame is provided below the touch display panel.

In the display apparatus, when a touch terminal touches a surface of the touch display panel, a pressure capacitance is generated in accordance with changes of a driving capacitance between the pressure sensing electrodes and the middle frame, so that the display apparatus generates a pressure control signal in accordance with the pressure capacitance,

As still another technical solution, an embodiment of the present invention also provides a manufacturing method of the touch display panel described above, comprises;

forming the first substrate;

forming the second substrate;

assembling the first substrate with the second substrate to form a cell;

forming the touch sensing electrodes at the side of the first substrate distal to the second substrate.

As yet another technical solution, an embodiment of the present invention also provides a driving method for the display apparatus described above, comprising:

when a touch terminal touches the surface of the touch display panel, detecting a pressure capacitance generated between the pressure sensing electrodes and the middle frame, and generating the pressure control signal in accordance with the pressure capacitance.

The driving method further comprises;

when a touch terminal touches the surface of the touch display panel, detecting a touch capacitance generated between the touch sensing electrodes and the driving electrodes, and generating a touch control signal in accordance with the touch capacitance.

In the touch display panel of the present invention and the manufacturing method thereof, the display apparatus of the present invention and the driving method therefor, the touch display panel comprises the first substrate and the second substrate, which are disposed opposite to each other, the strip-like touch sensing electrodes being provided at the side of the first substrate distal to the second substrate, the second substrate comprising the block-like common electrodes, and the block-like common electrodes being arranged in strips, wherein, orthographic projections of the strip-like touch sensing electrodes on the first or second substrate intersect with those of the strips of the block-like common electrodes, each strip of the common electrodes includes the plurality of driving electrodes and the plurality of pressure sensing electrodes, and the driving electrodes and the pressure sensing electrodes are arranged alternatively in the same layer. By using this touch display panel, the touch control function and the pressure control function can be achieved simultaneously without additionally providing electrodes for the touch display panel for achieving the pressure control function, which simplifies structures of the touch display panel and the display apparatus, reduces production costs thereof and improves product competitiveness.

### BRIEF DESCRIPTION OF THE DRAWINGS

FIG. 1 shows a top view of electrodes in an existing touch display panel.

FIG. 2 shows a schematic diagram of a structure of a touch display panel in accordance with a first embodiment of the present invention.

FIG. 3 shows a timing diagram of operations of the touch display panel in accordance with the first embodiment of the present invention.

FIG. 4 shows a top view of electrodes in the touch display panel in accordance with the first embodiment of the present invention.

FIG. 5 shows examples of connections between driving electrodes and driving electrode leads and connections between pressure sensing electrodes and pressure sensing electrode leads.

FIG. 6 shows a schematic diagram of a structure of a display apparatus in accordance with a second embodiment of the present invention.

FIG. 7 shows a flowchart diagram of a manufacturing method of a touch display panel in accordance with a third embodiment of the present invention.

FIG. 8a shows a schematic diagram of a structure formed after performing a step 101 in the manufacturing method of the touch display panel in accordance with the third embodiment of the present invention.

FIG. 8b shows a schematic diagram of a structure formed after performing a step 102 in the manufacturing method of the touch display panel in accordance with the third embodiment of the present invention.

FIG. 9 shows a flowchart diagram of a driving method for a display apparatus in accordance with a fourth embodiment of the present invention.

### DETAILED DESCRIPTION OF EMBODIMENTS

To make those skilled in the art better understand the technical solutions of the present invention, the present invention will be described below in detail in conjunction with accompanying drawings and specific embodiments.

### First Embodiment

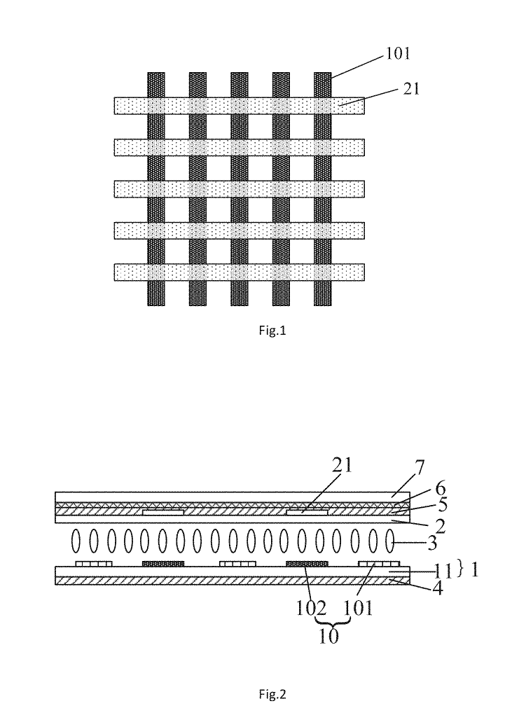

Referring to FIG. 2, the present embodiment provides a touch display panel comprising a first substrate 2 and a second substrate 1, which are disposed opposite to each other, strip-like touch sensing electrodes 21 being provided at a side of the first substrate 2 distal to the second substrate 1, the second substrate 1 comprising block-like common electrodes 10, and the block-like common electrodes 10 being arranged in strips, wherein, orthogonal projections of the strip-like touch sensing electrodes 21 on the first substrate 2 or the second substrate 1 intersect with those of the strips of the block-like common electrodes 10, each strip of the common electrodes 10 includes a plurality of driving electrodes 101 and a plurality of pressure sensing electrodes 102, and the driving electrodes 101 and the pressure sensing electrodes 102 are arranged alternatively in a same layer.

From FIG. 2 it can be seen that, the second substrate 1 comprises a second base 11 and the common electrodes 10, the common electrodes 10 are provided above the second base 11, and a second polarizer 4 is provided below the second base 11; the first substrate 2 and the second substrate 1 are disposed opposite to each other, a liquid crystal layer 3 is provided between the first substrate 2 and the second substrate 1, and the touch sensing electrodes 21 are provided at a side of the first substrate 2 distal to the liquid crystal layer 3 (i.e., above the first substrate 2 in the figure); a first polarizer 5 is provided above the touch sensing electrodes 21, and the first polarizer 5 covers the whole of the first substrate 2; a protective layer 6 is provided above the first polarizer 5, and a cover plate 7 is provided above the protective layer 6.

In the present embodiment, when a touch terminal touches a surface of the touch display panel, a touch capacitance is generated between the touch sensing electrodes 21 and the driving electrodes 101, so that the touch display panel generates a touch control signal in accordance with the touch capacitance.

Specifically, for example, when a finger (as an example of the touch terminal) of a user touches the cover plate 7 at the surface of the touch display panel, the touch of the finger makes a change in capacitance between the driving electrodes 101 and the touch sensing electrodes 21, thereby generating a touch capacitance. The touch display panel can generate a touch control signal in accordance with the touch capacitance, and the touch control signal is transferred through a metal wire (not shown in the figure) provided between the first substrate 2 and the first polarizer 5, so that a touch position of the finger on the surface of the touch display panel can be obtained, and a touch control function is achieved.

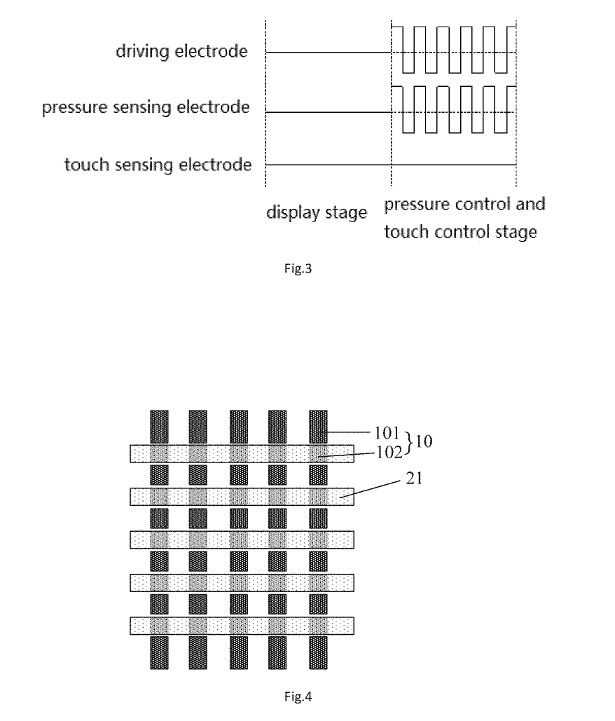

It should be noted that, as shown in FIG. 3, in a display stage, signals generated by the driving electrodes 101 as the common electrodes and the pressure sensing electrodes 102 are constant, and meanwhile, signals generated by the touch sensing electrodes 21 are also constant. Alternatively, the touch sensing electrodes 21 may not generate signals. When the touch terminal touches the surface of the touch display panel, that is, in a pressure control and touch control stage, the pressure sensing electrodes 102 and the driving electrodes 101 generate signals of a same type, but amplitudes of the signals may be different. Since the signals of the driving electrodes 101 are changed, and the signals of the touch sensing electrodes 21 remain unchanged, the capacitance between the driving electrodes 101 and the touch sensing electrodes 21 is changed. That is to say, when the touch terminal touches the surface of the touch display panel, the touch terminal also applies a pressure on the surface of the touch display panel. At this time, it is possible to perform a pressure control, that is to say, the touch control and the pressure control can be achieved simultaneously.

In the present embodiment, orthogonal projections of the touch sensing electrodes 21 on the first substrate 2 cover orthogonal projections of the pressure sensing electrodes 102 on the first substrate 2, that is, the pressure sensing electrodes 102 are provided at positions corresponding to positions of the touch sensing electrodes 21.

In this case, when the touch terminal touches the surface of the touch display panel, the touch sensing electrodes 21 have a shielding effect on the touch terminal, that is, the touch sensing electrodes 21 prevent a parasitic capacitance from being generated between the touch terminal and the pressure sensing electrodes 102.

In a case where the pressure sensing electrodes 102 are provided at positions corresponding to positions of the touch sensing electrodes 21, when the touch terminal touches the surface of the touch display panel, the touch sensing electrodes 21 have the shielding effect on the touch terminal so that the parasitic capacitance having influence on the touch capacitance is prevented from being generated between the touch terminal and the pressure sensing electrodes 102, an accuracy of the touch control is improved.

As shown in FIG. 4, in the present embodiment, the touch sensing electrodes 21 are arranged in rows, and the common electrodes 10 are arranged in columns,

From FIG. 4 it can be seen that, the common electrodes 10 are arranged in columns, each column of the common electrodes 10 includes a plurality of driving electrodes 101 and a plurality of pressure sensing electrodes 102, and the driving electrodes 101 and the pressure sensing electrodes 102 are arranged alternatively, so that the driving electrodes 101 and the pressure sensing electrodes 102 are provided in a same layer, wherein, the driving electrodes 101 and the pressure sensing electrodes 102 are block-like electrodes. It facilitates the arrangement of the driving electrodes 101 and the pressure sensing electrodes 102 when the driving electrodes 101 and the pressure sensing electrodes 102 are block-like electrodes.

It should be noted that, the pressure sensing electrodes 102 in the present embodiment are self-capacitance electrodes, the pressure sensing electrodes 102 in each column of the common electrodes 10 are separated from each other, and each pressure sending electrode 102 outputs signals through a separate lead. The driving electrodes 101 are mutual-capacitance electrodes, and the driving electrodes 101 in each column of the common electrodes 10 are connected with each other and then output signals through a same lead.

FIG. 5 shows examples of connections between driving electrodes 101 and driving electrode leads and connections between pressure sensing electrodes 102 and pressure sensing electrode leads. In FIG. 5, the upper-left dashed frame denotes one driving electrode, and the lower-right dashed frame denotes one pressure sensing electrode, and in this example, a touch unit is illustrated by taking a size of 4×2 as an example. It should be understood that, the touch unit may have any of sizes of 5×5, 10×10 or other desired sizes, if required.

Optionally, the touch display panel is an improved fringe filed switching (IFFS) type display panel.

Certainly, the type of the touch display panel of the present invention is not limited thereto, and the touch display panel may also be display panels of other types, such as advanced super dimension switch (ADS) type display panel, as long as the common electrodes can be configured to include pressure sensing electrodes and driving electrodes arranged in a same layer, which will not be repeatedly described herein.

The touch display panel of the present embodiment comprises a first substrate 2 and a second substrate 1, which are disposed opposite to each other, strip-like touch sensing electrodes 21 being provided at the side of the first substrate 2 distal to the second substrate 1, the second substrate 1 comprising block-like common electrodes 10, the block-like common electrodes 10 being arranged in strips, wherein, orthogonal projections of the strip-like touch sensing electrodes 21 on the first substrate 2 or the second substrate 1 intersect with those of the strips of the block-like common electrodes 10, each strip of the common electrodes 10 includes a plurality of driving electrodes 101 and a plurality of pressure sensing electrodes 102, and the driving electrodes 101 and the pressure sensing electrodes 102 are arranged alternatively in a same layer. By using this touch display panel, the touch control function and the pressure control function can be achieved simultaneously without additionally providing electrodes for the touch display panel for achieving the pressure control function, which simplifies structures of the touch display panel and the display apparatus, reduces production costs thereof and improves product competitiveness.

### Second Embodiment

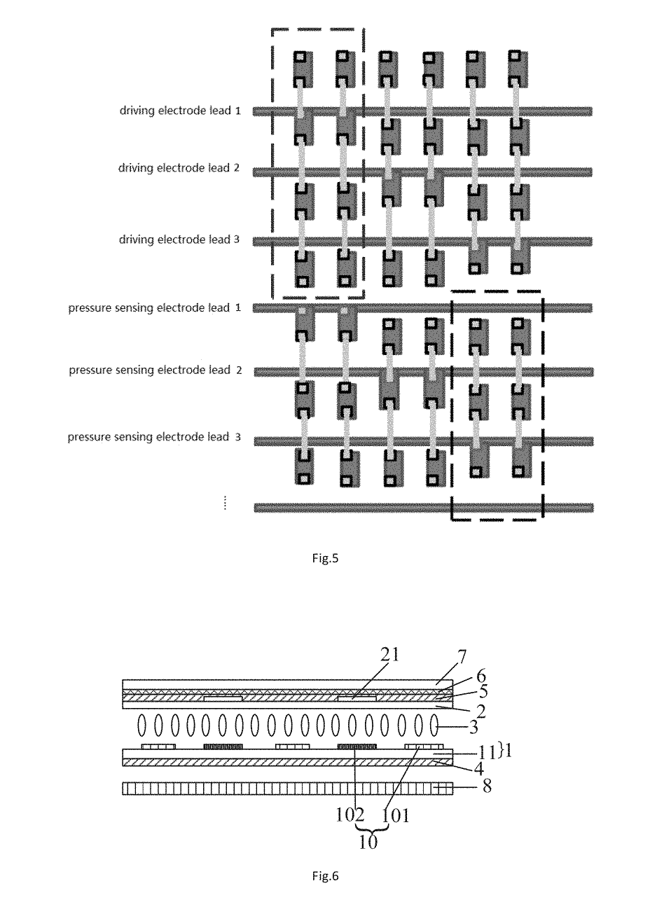

Referring to FIG. 6, the present embodiment provides a display apparatus comprising the touch display panel of the first embodiment and a middle frame 8, wherein the middle frame 8 is provided below the touch display panel to support the touch display panel and is made of a conductive metal. It should be understood that, the middle frame may be an inherent metal frame in the display apparatus (e.g., a mobile phone), or, a backplate including a metal bottom may be made and used as the middle frame, or, a metal backplate is used as the middle frame, and so on, as long as the metal middle frame 8 is provided below the touch display panel to support the touch display panel and a capacitance can be generated between the middle frame and the pressure sensing electrodes of the touch display panel.

In such a configuration, when a touch terminal touches the surface of the touch display panel, a pressure capacitance is generated due to changes of the driving capacitance between the pressure sensing electrodes 102 and the middle frame 8 located below the touch display panel, so that the display apparatus generates a pressure control signal in accordance with the pressure capacitance.

The pressure control signal is generated in accordance with the pressure capacitance as follows. When no touch occurs, a capacitance between the pressure sensing electrodes 102 and the middle frame 8 is C0. For example, a square wave voltage is applied to the pressure sensing electrodes 102 to perform charge, the time during which the potential of the capacitance between the pressure sensing electrodes 102 and the middle frame 8 changes from the lowest potential to a certain high potential due to the charge is referred to as a read time, and occurrence of a touch is determined in accordance with the change of the read time. Since the capacitance between the pressure sensing electrodes 102 and the middle frame 8 is increased to be C1 when a touch occurs, when the same square wave voltage is used to charge, the read time required for the potential of the capacitance between the pressure sensing electrodes 102 and the middle frame 8 to rise to the same high potential increases. By comparing the read times required for charging into the same high potential, whether the pressure occurs or not can be determined and different pressure control signals (i.e., read potentials) may be further obtained in accordance with different values of the capacitances. Alternatively, in a case where the read times are identical, whether the touch occurs or not may be determined in accordance with changes of potentials. When no touch occurs, the capacitance between the pressure sensing electrodes 102 and the middle frame 8 is C0. For example, a square wave voltage is applied to the pressure sensing electrodes 102 to perform charge. Since the capacitance between the pressure sensing electrodes 102 and the middle frame 8 is increased to be C1 when a touch occurs, when the same square wave voltage is used to charge for the same read time, the thus reached potential is lowered. Thus, by comparing the potentials reached by charging for the same read times, whether a pressure occurs or not can be determined, and different pressure control signals (i.e., read potentials) may be further obtained in accordance with different values of the capacitances.

A pressure level corresponding to a pressure control signal may be obtained in accordance with the pressure control signal, and different instructions may be performed in accordance with different pressure levels, that is, multiple-level pressure sensing can be achieved. For example, an instruction corresponding to a pressure level of “1” in a “music” application may be used for playing music, an instruction corresponding to a pressure level of “2” may be used for stopping music, an instruction corresponding to a pressure level of “3” may be used for pausing music, and so on, which will not repeatedly described herein.

For example, when a finger (as an example of the touch terminal) of a user touches the cover plate 7 at the surface of the touch display panel, the touch of the finger makes a change in the capacitance between the driving electrodes 101 and the touch sensing electrodes 21, thereby generating a touch capacitance. The display apparatus can generate a touch control signal in accordance with the touch capacitance, and the touch control signal is transferred through a metal wire (not shown in the figure) provided between the first substrate 2 and the first polarizer 5, so that the touch position of the finger on the surface of the touch display panel can be obtained, and a touch control function is achieved.

It should be noted that, when the finger touches the surface of the touch display panel, the finger also applies a pressure on the surface of the touch display panel. At this time, it is possible to achieve pressure control, that is, the touch control and the pressure control can be performed simultaneously.

In the present embodiment, the display apparatus may be any product or part having display function, such as a liquid crystal display panel, an electronic paper, a mobile phone, a tablet computer, a TV, a display, a notebook computer, a digital photo frame, and a navigator.

The display apparatus of the present embodiment comprises the touch display panel of the first embodiment, specific descriptions of which can be referred to the first embodiment.

The display apparatus of the present embodiment comprises the touch display panel of the first embodiment and the middle frame 8, the touch display panel comprising a first substrate 2 and a second substrate 1, which are disposed opposite to each other, strip-like touch sensing electrodes 21 being provided at the side of the first substrate 2 distal to the second substrate 1, the second substrate 1 comprising block-like common electrodes 10, and the block-like common electrodes 10 being arranged in strips, wherein, orthogonal projections of the strip-like touch sensing electrodes 21 on the first substrate 2 or the second substrate 1 intersect with those of the strips of the block-like common electrodes 10, each strip of the common electrodes 10 includes a plurality of driving electrodes 101 and a plurality of pressure sensing electrodes 102, and the driving electrodes 101 and the pressure sensing electrodes 102 are arranged alternatively in a same layer. When a touch terminal touches the surface of the touch display panel, a pressure capacitance is generated in accordance with changes of the driving capacitance between the pressure sensing electrodes 102 and the middle frame 8 located below the touch display panel so that the display apparatus can simultaneously achieve the touch control function and the pressure control function without additionally providing electrodes for the touch display panel for achieving the pressure control function, which simplifies structures of the touch display panel and the display apparatus, reduces production costs thereof and improves product competitiveness.

### Third Embodiment

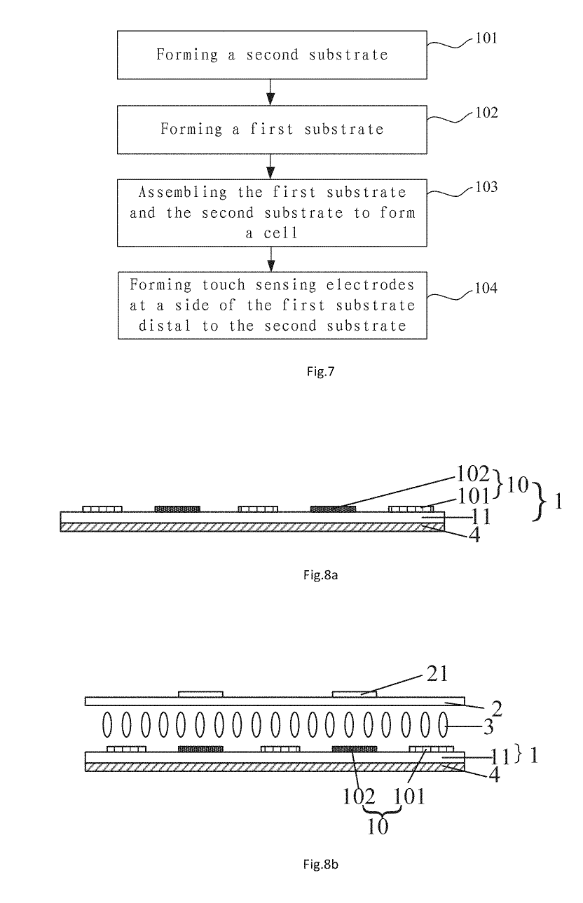

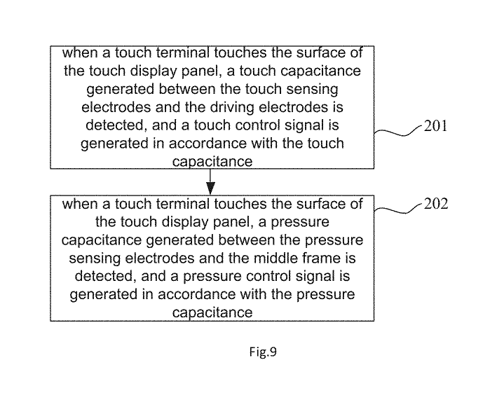

Referring to FIGS. 7 and 8a-8b, the present embodiment provides a manufacturing method of the touch display panel of the first embodiment, the manufacturing method comprises following steps 101 to 104.

In step 101, as shown in FIG. 8a, the second substrate 1 is formed, the second substrate 1 comprising the common electrodes 10, which include the driving electrodes 101 and the pressure sensing electrodes 102.

In the present embodiment, the common electrodes 10 are arranged in columns, and in each column of the common electrodes 10, the driving electrodes 101 and the pressure sensing electrodes 102 are provided alternatively.

From FIG. 4 it can be seen that, the common electrodes 10 are arranged in columns, each column of the common electrodes 10 includes a plurality of driving electrodes 101 and a plurality of pressure sensing electrodes 102, which are arranged alternatively, so that the driving electrodes 101 and the pressure sensing electrodes 102 are provided in a same layer.

In the present embodiment, the driving electrodes 101 and the pressure sensing electrodes 102 are block-like electrodes. It facilitates the arrangement of the driving electrodes 101 and the pressure sensing electrodes 102 when the driving electrodes 101 and the pressure sensing electrodes 102 are block-like electrodes.

In step 102, as shown in FIG. 8b, the first substrate 2 is formed.

In step 103, the first substrate 2 and the second substrate 1 are assembled to form a cell.

In step 104, the touch sensing electrodes 21 are formed at the side of the first substrate 2 distal to the second substrate 1.

In the present embodiment, the pressure sensing electrodes 102 are provided at positions corresponding to positions of the touch sensing electrodes 21 after the first substrate 2 and the second substrate 1 are assembled to form the cell.

In a case where the pressure sensing electrodes 102 are provided at positions corresponding to positions of the touch sensing electrodes 21, when a touch terminal touches the surface of the touch display panel, the touch sensing electrodes 21 can prevent the parasitic capacitance having influence on the touch capacitance from being generated between the touch terminal and the pressure sensing electrodes 102, an accuracy of the touch control is improved.

It should be noted that, the pressure sensing electrodes 102 in the present embodiment are self-capacitance electrodes, the pressure sensing electrodes 102 in each column of the common electrodes 10 are separated from each other, and each pressure sending electrode 102 outputs signals through a separate lead. The driving electrodes 101 are mutual-capacitance electrodes, and the driving electrodes 101 in each column of the common electrodes 10 are connected with each other and then output signals through a same lead.

Certainly, the manufacturing method of the present embodiment further comprises steps of successively forming the first polarizer 5, the protective layer 6 and the cover plate 7 above the touch sensing electrodes 21, which will not be described in detail herein.

The manufacturing method of the present embodiment is used for manufacturing the touch display panel of the first embodiment, specific descriptions of which can be referred to the first embodiment.

In the touch display panel manufactured by the manufacturing method of the present embodiment, by configuring the common electrodes 10 to include the driving electrodes 101 and the pressure sensing electrodes 102, which are provided in a same layer, the touch display panel can simultaneously achieve the touch control function and the pressure control function without additionally providing electrodes for the touch display panel for achieving the pressure control function, which simplifies structures of the touch display panel and the display apparatus, reduces production costs thereof and improves product competitiveness.

### Fourth Embodiment

Referring to FIG. 9, the present embodiment provides a driving method for the display apparatus of the second embodiment, which comprises following steps 201 to 202.

In step 201, when a touch terminal touches the surface of the touch display panel, a touch capacitance generated between the touch sensing electrodes 21 and the driving electrodes 101 is detected, and a touch control signal is generated in accordance with the touch capacitance.

Specifically, for example, when a finger (as an example of the touch terminal) of a user touches the cover plate 7 at the surface of the touch display panel, the touch of the finger makes a change in a capacitance between the driving electrodes 101 and the touch sensing electrodes 21, thereby generating a touch capacitance. The display apparatus can generate a touch control signal in accordance with the touch capacitance, and the touch control signal is transferred through a metal wire (not shown in the figure) provided between the first substrate 2 and the first polarizer 5, so that a touch position of the finger on the surface of the touch display panel can be obtained, and a touch control function is achieved.

In step 202, when a touch terminal touches the surface of the touch display panel, a pressure capacitance generated between the pressure sensing electrodes 102 and the middle frame 8 is detected, and a pressure control signal is generated in accordance with the pressure capacitance,

A pressure level corresponding to a pressure control signal may be obtained in accordance with the pressure control signal, and different instructions may be performed in accordance with different pressure levels, that is, multiple-level pressure sensing can be achieved. For example, an instruction corresponding to a pressure level of “1” in a “music” application may be used for playing music, an instruction corresponding to a pressure level of “2” may be used for stopping music, an instruction corresponding to a pressure level of “3” may be used for pausing music, and so on, which will not repeatedly described herein.

It should be noted that, when a finger touches the surface of the touch display panel, the finger also applies a pressure on the surface of the touch display panel. At this time, it is possible to achieve pressure control, that is, the touch control and the pressure control can performed simultaneously. That is to say, steps 201 and 202 may be performed simultaneously.

The driving method of the present embodiment is used for driving the display apparatus of the second embodiment, which comprises the touch display panel of the first embodiment and the middle frame 8, the touch display panel comprising a first substrate 2 and a second substrate 1, which are disposed opposite to each other, strip-like touch sensing electrodes 21 being provided at the side of the first substrate 2 distal to the second substrate 1, the second substrate 1 comprising block-like common electrodes 10, and the block-like common electrodes 10 being arranged in strips, wherein, orthogonal projections of the strip-like touch sensing electrodes 21 on the first substrate 2 or the second substrate 1 intersect with those of the strips of the block-like common electrodes 10, each strip of the common electrodes 10 includes a plurality of driving electrodes 101 and a plurality of pressure sensing electrodes 102, and the driving electrodes 101 and the pressure sensing electrodes 102 are arranged alternatively in a same layer. When a touch terminal touches the surface of the touch display panel, a pressure capacitance is generated in accordance with changes of the driving capacitance between the pressure sensing electrodes 102 and the middle frame 8 located below the touch display panel, and the display apparatus generates a pressure control signal in accordance with the pressure capacitance so that the display apparatus using the touch display panel can simultaneously achieve the touch control function and the pressure control function without additionally providing electrodes for the touch display panel for achieving the pressure control function, which simplifies structures of the touch display panel and the display apparatus, reduces production costs thereof and improves product competitiveness.

It should be understood that, the above embodiments are only exemplary embodiments used for explaining the principle of the present invention, but the present invention is not limited thereto. A person skilled in the art can make various variations and modifications without departing from spirit and essence of the present invention, and these variations and modifications are also considered to be within the protection scope of the present invention.

1. A touch display panel, comprising a first substrate and a second substrate, which are disposed opposite to each other, strip-like touch sensing electrodes being provided at a side of the first substrate distal to the second substrate, the second substrate comprising block-like common electrodes, and the block-like common electrodes being arranged in strips, wherein, orthogonal projections of the strip-like touch sensing electrodes on the first substrate or the second substrate intersect with those of the strips of the block-like common electrodes, each strip of the common electrodes includes a plurality of driving electrodes and a plurality of pressure sensing electrodes, and the driving electrodes and the pressure sensing electrodes are arranged alternatively in a same layer.

2. The touch display panel of claim 1, wherein, when a touch terminal touches a surface of the touch display panel, a touch capacitance is generated between the touch sensing electrodes and the driving electrodes, so that the touch display panel generates a touch control signal in accordance with the touch capacitance.

3. The touch display panel of claim 1, wherein orthogonal projections of the touch sensing electrodes on the first substrate cover orthogonal projections of the pressure sensing electrodes on the first substrate.

4. The touch display pane of claim 3, wherein, when a touch terminal touches a surface of the touch display panel, the touch sensing electrodes prevent a parasitic capacitance from being generated between the touch terminal and the pressure sensing electrodes.

5. The touch display panel of claim 1, wherein, the touch sensing electrodes are arranged in rows, and the common electrodes are arranged in columns.

6. The touch display panel of claim 1, wherein, the touch display panel is an improved fringe filed switching type display panel.

7. A display apparatus, comprising the touch display panel of claim 1 and a middle frame, wherein the middle frame is configured to support the touch display panel and is made of a conductive metal, and the middle frame is provided below the touch display panel.

8. The display apparatus of claim 7, wherein, when a touch terminal touches a surface of the touch display panel, a pressure capacitance is generated between the pressure sensing electrodes and the middle frame, so that the display apparatus generates a pressure control signal in accordance with the pressure capacitance.

9. The display apparatus of claim 7, wherein orthogonal projections of the touch sensing electrodes on the first substrate cover orthogonal projections of the pressure sensing electrodes on the first substrate.

10. The display apparatus of claim 7, wherein, the touch sensing electrodes are arranged in rows, and the common electrodes are arranged in columns.

11. A manufacturing method of the touch display panel of claim 1, comprising steps of:
forming the first substrate;
forming the second substrate;
assembling the first substrate with the second substrate to form a cell;
forming the touch sensing electrodes at the side of the first substrate distal o the second substrate.

12. The manufacturing method of claim 11, wherein orthogonal projections of the touch sensing electrodes on the first substrate cover orthogonal projections of the pressure sensing electrodes on the first substrate.

13. The manufacturing method of claim 11, wherein, the touch sensing electrodes are arranged in rows, and the common electrodes are arranged in columns.

14. A driving method for the display apparatus of claim 7, comprising:
when a touch terminal touches a surface of the touch display panel, detecting a pressure capacitance generated between the pressure sensing electrodes and the middle frame, and generating a pressure control signal in accordance with the pressure capacitance.

15. The driving method of claim 14, further comprising:
when a touch terminal touches the surface of the touch display panel, detecting a touch capacitance generated between the touch sensing electrodes and the driving electrodes, and generating a touch control signal in accordance with the touch capacitance.
